(19) United States
(12) Patent Application Publication
(10) Pub. No.: US 2008/0137061 A1
(43) Pub. Date: Jun. 12, 2008

(54) Displacement Measurement Sensor Using the Confocal Principle

(76) Inventor: Christopher John Rush, Forestville, CA (US)

Correspondence Address: Christopher Rush, 7475 Poplar Dr, Forestville, CA, 95436, US

(21) Appl. No.: 11/949,920

(22) Filed: Dec. 4, 2007

Related U.S. Application Data
(60) Provisional application No. 60/868,999, filed on Dec. 7, 2006.

(51) Int. Cl. G01C 3/08

(52) U.S. Cl. 356/4.04

(57) ABSTRACT

A displacement measurement sensor using the confocal principle for measuring small changes in distance to a specular target surface comprises a monochromatic light source such as a laser diode 12, an aperture, 31 an objective lens system 44 possessing spherical aberration that separates the monochromatic light at different focal distances according to the magnitude of angular deviation from the optical axis. Each distance of the target surface from the objective lens will select specific angular rays able to retrace the path through the objective lens and aperture. Each angle then will correspond to specific distance. The angle measurement is determined by detecting the light impinging on a light sensitive electronic detector array 36.

This application claims the benefit of U.S. Provisional Application No. 60/868,999 filed Dec. 07, 2006.

### FIELD OF THE INVENTION

The present invention relates generally to the use of a non-contact optical apparatus to measure displacement of a target over very small incremental changes in distance. More particularly, it relates to an apparatus and method for measuring target displacement when the target surface reflectivity is specular in nature.

### BACKGROUND OF THE INVENTION

Optical distance measurement is widely used in the semiconductor wafer manufacturing industry. The need for precise height information is used primarily in the control of devices that inspect the wafer surfaces for errors or contamination. Semiconductor wafers have specular reflecting surfaces.

Confocal measuring devices are used to measure displacement when the target surface is specular. When the target surface reflectivity is diffuse, optical triangulation sensors are often used. In these devices light projected along a line that is perpendicular to the surface is usually observed at some angle different from perpendicular and the location of the focused image of the light on the diffuse surface is projected on to a light sensitive detecting device. An example of one such devise is disclosed in U.S. Pat. No. 6,088,110.

When the surface is specular, light projected along a line that is perpendicular to the target surface is reflected directly back along the perpendicular and so no distance information can be determined since the return angle is the same for all distances. The confocal principle is therefore the preferred method for measuring distance optically for specular surfaces. Many such confocal systems are known. Examples of such devices are disclosed in U.S. Pat. Nos. 6,934,019, 6,657,216, 6,982,824, and 7,038,793.

The operating principles for existing confocal devices rely on either one or the other of two phenomena:

In the first type of confocal measuring system the chromatic aberration of the objective lens is exploited to determine the distance. The confocal imaging optical setup is an optical setup for imaging a point of light source into a sharp focused second point and then reversing the image from the second point onto a tiny spatial filter. Such an optical setup is absolutely blind for all the space except for the sharply focused second point. Since each wavelength has a different focus length, said setup can be used as a height-measuring device to measure the height of a surface point. A white light beam is separated to its constituent wavelength beams by the optic head and each beam illuminates the surface. The illumination is reflected back through the confocal imaging setup to a spectrometer. Only one wavelength is passed the confocal imaging optical setup, according to the height of the surface, which matches the focal length. The wavelength is detected by the spectrometer and translated to the height of the surface point according to a calibration table. Energy efficiency for devices of this type is low and there is considerable difficulty in coupling broad spectrum white light to a tightly focused point as the system requires.

The second type uses chromatically corrected optics that are mounted on a moving stage. Focus is determined when the return rays pass exactly through a small aperture. To make a measurement, then, the optics are moved by such devices as voice coil or piezoelectric actuators. Displacement can be determined for the target by measuring the displacement of the optics. The disadvantage of this device is that moving the optical components is relatively slow. US patent 7,038,793 discloses a measuring device that utilizes this principle.

Thus, there exists a need for an optical measuring device that can determine the displacement of a target when the surface reflectivity is specular.

Additionally, there exists a need for an optical measuring device that can determine the displacement of a target that has a fast response.

### SUMMARY OF THE INVENTION

A primary object of the invention is to provide a means for accurately determining the distance to a target that is not affected by absolute target reflectivity or variations in source illumination when the target surface reflectivity is specular.

Another object of the invention is to increase the sensitivity of the system so that minute changes in displacement can be measured.

Another object of the invention is to provides a displacement measurement sensor with a fast response.

The non-contact measuring probe of the present invention achieves these objectives by providing an optical probe consisting of an optical objective component possessing spherical aberration that is optically coupled to a small aperture. The aperture functions to both transmit and receive illumination rays through the objective component and incident on and reflected by the target surface. The aperture is further provided with a means to insert a family of monochromatic light rays possessing a variety of angles. This is accomplished by focusing the light from a laser diode or superluminescent diode (SLD) through the aperture. The cone of focused rays contains the full range of angular distribution with respect to the optical axis. Rays returned through the system contain only a subset of the original rays. This subset of angular distribution rays is determined by the geometry of the distance between the objective lens, or lens system, and the target surface. An electronic detector is situated some distance from the aperture. It is oriented to register the angle of returned rays and thereby provide a measurement of the distance. The cone of light emerging from the aperture is projected on to the surface of a position-sensitive transducer PSD or a linear CCD array or two-dimensional array. The diameter of the cone shaped light is easily measured as the location of the centroid of the of optical power distribution on a linear array or as the best fit of a circular function to the power distribution as registered on the two-dimensional array.

The confocal measurement principle requires that light rays reflected from the target surface are returned exactly along the path that is symmetric with the incident rays. The invention thus, achieves the goal of measuring the displacement of a specular surface.

The confocal measurement principle depends on the interpretation of the angular information in the return rays. The geometric properties of the rays—their angular disposition—are not altered by variations in absolute surface reflectivity or illumination source intensity variation. This achieves the objective of making measurements that are immune to variation in surface reflectivity and source variation.

Position sensing of optical energy on multi-element linear or two-dimensional arrays may be realized with very high precision. This achieves the object of the invention to devise a probe having high accuracy.

Position sensing of optical energy on multi-element linear or two-dimensional arrays may be realized electronically and without the use of any moving mechanical parts. Thus, the invention achieves the objective of measuring with a fast response.

### BRIEF DESCRIPTION OF THE DRAWINGS

FIG. 1 shows a diagram of the preferred embodiment of the invention.

FIG. 2 shows a diagram for an alternate embodiment where the objective lens is a spherical lens.

FIG. 3a-3d show ray-trace simulations for the illumination distribution on the plane of the detector for a series of increasing distances of the target .

### DETAILED DESCRIPTION OF THE INVENTION

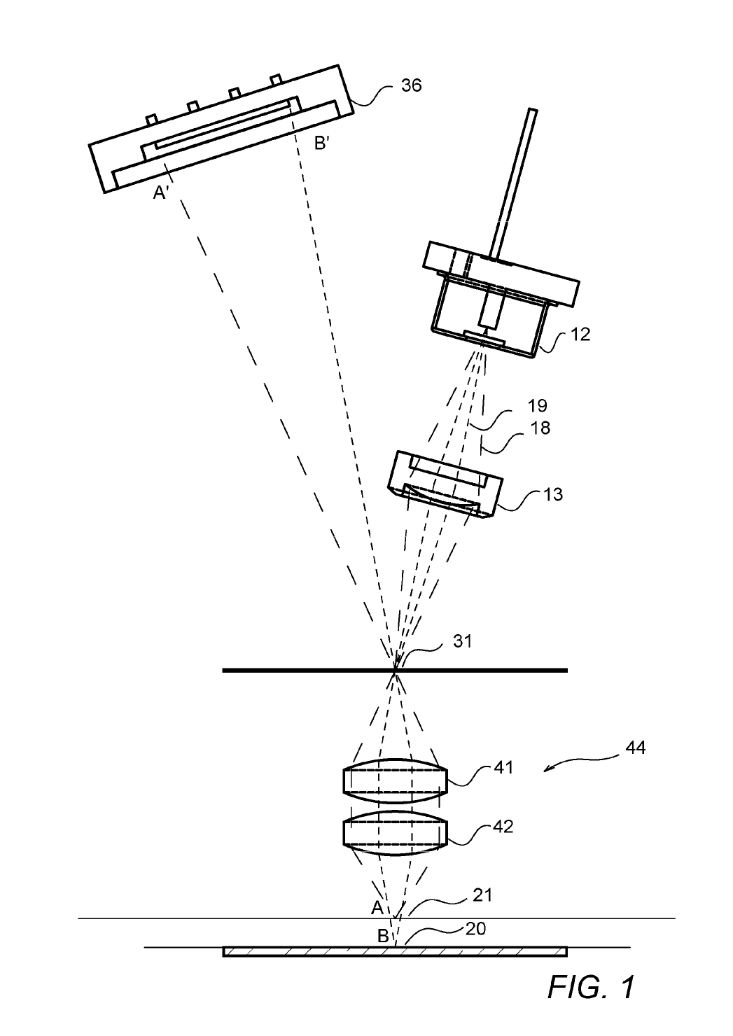

A displacement measurement sensor will now be described according to the invention. Referring to FIG. 1 in the preferred embodiment the device consists of a laser diode 12 projecting a cone of monochromatic light rays 18,19 through a small aperture using an intermediate lens 13 which gathers light from the laser diode 12 and focuses it through the small aperture 31. Within the cone of focused rays of light there is a full range of angular distributions. Some rays 19 make small angles with respect to the optical axis, while other rays 18 make relatively larger angles with respect to the optical axis. The axis of the laser and lens optical system is tilted with respect to the optical axis so that on-axis rays are not transmitted through the aperture to the objective lens system 44. Light rays emerging from the aperture 31 are refracted by objective lens system 44. A property of lens system 44 is that it possesses spherical aberration. Spherical aberration is described as the difference in focal length according to the distance of the rays from the optical axis of the lens. In this preferred embodiment the rays that are refracted by the region of the lens near to the optical axis—also called the paraxial rays—focus at a distance relatively far from the lens system 44 at point B. Rays relatively far from the optical axis—also called tangential rays—focus at a distance relatively nearer to the lens at point A. It follows from this that rays reflected by the specular target 20 will only travel back through the optical system after a reflection angle that is exactly equal to the angle of incidence. This is the fundamental definition of specular reflection. Thus if the target is near to the lens the reflected rays that will be able to travel back through the system will be the tangential rays. When the target is relatively far from the lens, the reflected rays able to traverse the system will only be the paraxial rays. In this way the height position of the target surface will select the subset of the family of all rays that are able to travel the exact reverse path and re-emerge from the aperture 31. Rays emerging from aperture 31 are distributed in a cone shape. The apex angle of the cone of rays is determined by the selection of the subset from the family of all angles according to the principle described above. Rays emerging from aperture 31 fall on detector array 36. This is an array of light sensitive elements such as is manufactured by Texas Advanced Optoelectronics Solutions, Inc. product number TSLW1401. Array 36 registers an intensity distribution according to the angular distribution of rays in the emergent cone of rays. Low angle rays from a small apex cone of paraxial rays will register higher intensity illumination at region B′ on the detector array. Higher angle tangential rays from a relatively nearer target will register higher intensity illumination on region A′ on the detector array.

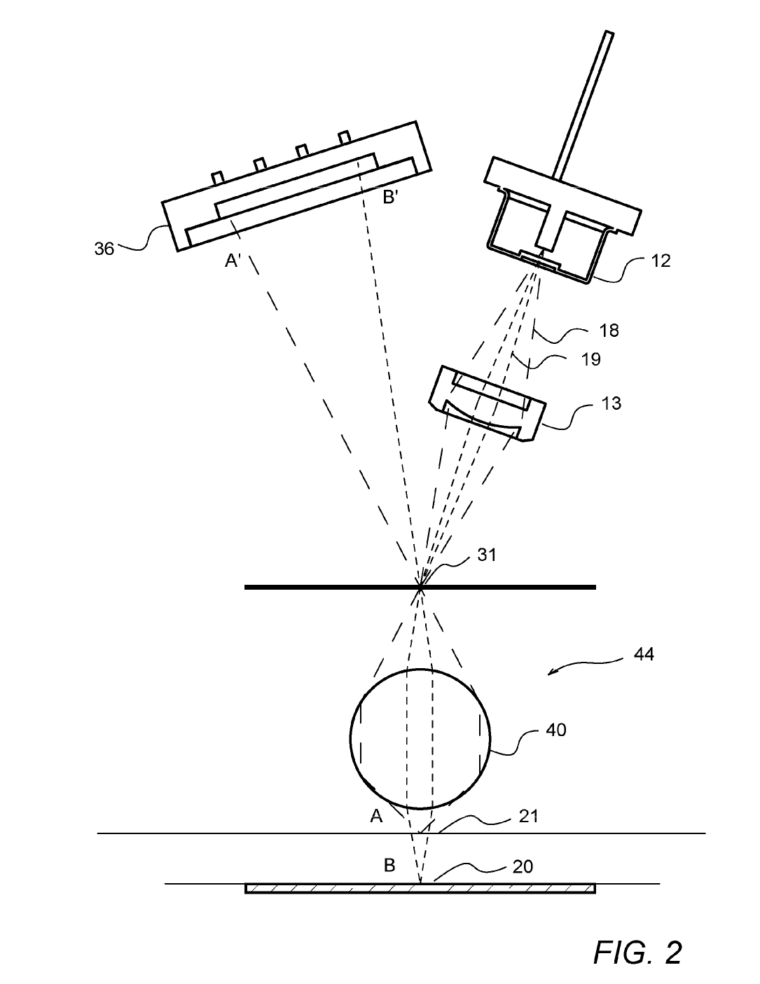

Another embodiment of the present invention is shown in FIG. 2. In this embodiment the objective lens system is composed of a single spherical lens. Such lenses are known to possess a high degree of spherical aberration. Spherical aberration may also be controlled to tailor the specific characteristics or range and resolution by selecting objective lenses with different curvatures and indices of refraction. Additionally the index of refraction need not be radially uniform across the component. Gradient index materials, so-called GRIN lenses, may be used in alternative embodiments.

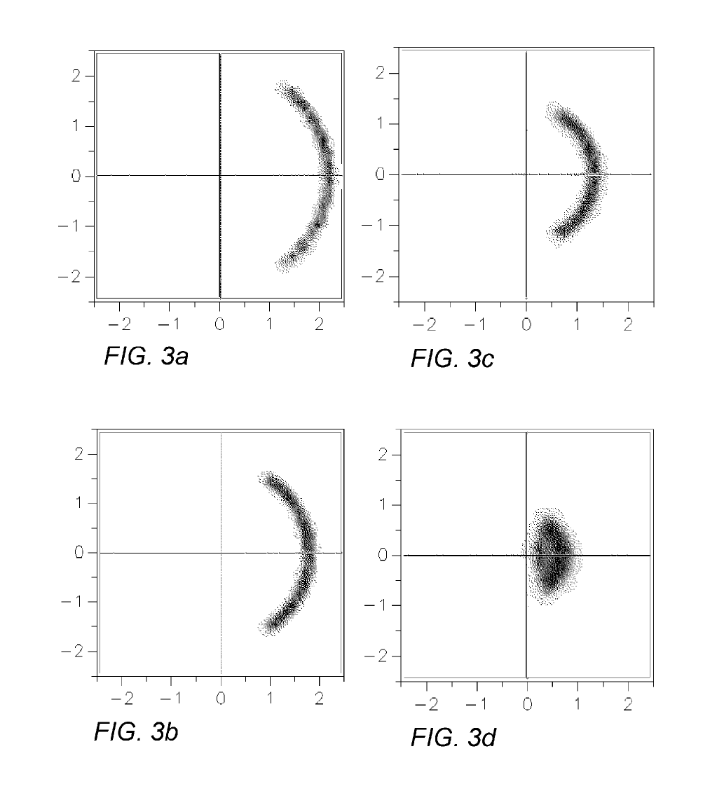

FIG. 3a-d Show the illumination pattern produced by the system for various distances of the target to the lens. For the preferred embodiment described in FIG. 1 the scale of the images is shown in millimeters and if FIG. 3a is given as the zero datum then each successive image represents an increasing distance change of 0.5 mm.

It is now apparent that the non-contact measuring probe sensor of the present invention, as described and illustrated above, shows many improvements over available sensors. It is to be understood, however, that although certain preferred embodiments have been disclosed and described above, other embodiments and changes are possible without departing from that which is the invention disclosed herein. It is intended therefore that claims in any non-provisional patent claiming the benefit of this provisional application define the invention, and that the structure within the scope of those claims and their equivalents be covered thereby.

I claim:

1. A confocal optical measuring probe for measuring distance to a reflective target, the probe comprising:
a light source for projecting focused light rays through a small aperture in a thin plate,
an optical component possessing spherical aberration that receives rays from the said aperture, and produces a distribution of focal points at varying distances along the measuring axis,
said second optical component for receiving reflected rays from the target for focusing rays into the said small aperture, and
a light detector for measuring the angle of rays emerging from said small aperture.

2. A confocal optical measuring probe of claim 1 wherein: said light source includes a laser.

3. A confocal optical measuring probe of claim 1 wherein: said light source includes a superluminescent diode.

4. A confocal optical measuring probe of claim 1 wherein: said light source includes an LED.

5. A confocal optical measuring probe of claim 1 wherein: said optical component possessing spherical aberration comprises a plurality of lenses.

6. A confocal optical measuring probe of claim 1 wherein: said optical component possessing spherical aberration comprises a gradient index lens.

7. A confocal optical measuring probe of claim 1 wherein: said light detector includes a linear array.

8. A confocal optical measuring probe of claim 1 wherein: said light detector includes a position sensitive detector
